(19) United States
(12) Patent Application Publication
(10) Pub. No.: US 2026/0156016 A1
(43) Pub. Date: Jun. 4, 2026

(54) METHOD FOR NETWORK SPLIT TUNNELING, STORAGE MEDIUM, AND ELECTRONIC DEVICE

(71) Applicant: GEARUP PORTAL PTE. LTD., Singapore (SG)

(72) Inventors: Tianjiao YANG, Singapore (SG); Zhouye WEI, Singapore (SG); Jieyang YANG, Singapore (SG); Wei CHAN, Singapore (SG)

(73) Assignee: GEARUP PORTAL PTE. LTD., Singapore (SG)

(21) Appl. No.: 19/119,788

(22) PCT Filed: May 22, 2023
(86) PCT No.: PCT/SG2023/050352

§ 371 Date: Apr. 10, 2025

(51) Int. Cl. H04L 12/46; H04L 41/082; H04L 41/22; H04L 47/2475

(52) U.S. Cl. CPC H04L 12/4633; H04L 41/082; H04L 41/22; H04L 47/2475

(57) ABSTRACT

A method for network split tunneling, a storage medium, and an electronic device are provided. The method includes: acquiring request traffic and determining a target object for split tunneling corresponding to the request traffic based on the request traffic; determining whether the target object belongs to pre-configured objects for split tunneling; and in response to determining that the target object belongs to the pre-configured objects, querying, based on mapping relationships between the pre-configured objects and VPN tunnels, a target VPN tunnel corresponding to the target object, and forwarding the request traffic to a tunnel node corresponding to the target VPN tunnel.

### CROSS-REFERENCE TO RELATED APPLICATIONS

This disclosure is a U.S. National phase application of International Application No. PCT/SG 2023/050352, filed on May 22, 2023, the entire content of which is incorporated herein by reference for all purposes.

### TECHNICAL FIELD

This disclosure relates to the field of computer technology, and in particular to a method for network split tunneling, a device for network split tunneling, a computer-readable storage medium, and an electronic device.

### BACKGROUND

A Virtual Private Network (VPN) is a private network established over a public network, which can be used to enhance the security and reliability of data transmission.

In related technologies, on the iOS operating systems, VPN clients are required to connect through the VPN network when forwarding request traffic. However, due to restrictions on permission to read or access installed applications, split tunneling control within the VPN network is unachievable. On the Android systems, while applications need to be designated to connect through the VPN network or bypass it, there is no capability to implement customized split tunneling controls for different applications.

It should be noted that the information disclosed above in the “BACKGROUND” section is only used to enhance the understanding of the background of this disclosure and may include information that does not constitute prior art known to those of ordinary skill in the art.

### SUMMARY

This disclosure provides a method for network split tunneling, a device for network split tunneling, a computer-readable storage medium, and an electronic device.

According to a first aspect of this disclosure, a method for network split tunneling is provided. The method includes: acquiring request traffic and determining a target object for split tunneling corresponding to the request traffic based on the request traffic; determining whether the target object belongs to pre-configured objects for split tunneling; and in response to determining that the target object belongs to the pre-configured objects, querying, based on mapping relationships between the pre-configured objects and VPN tunnels, a target VPN tunnel corresponding to the target object, and forwarding the request traffic to a tunnel node corresponding to the target VPN tunnel.

According to a second aspect of this disclosure, a non-transitory computer-readable storage medium having a computer program stored thereon is provided. When the computer program is executed by a processor, it causes the processor to implement the method for network split tunneling according to the first aspect and possible implementations thereof.

According to a third aspect of this disclosure, an electronic device is provided. The electronic device includes: a processor; and a memory for storing instructions executable by the processor. The processor is configured to execute the method for network split tunneling according to the first aspect and possible implementations thereof by executing the instructions.

### BRIEF DESCRIPTION OF THE DRAWINGS

The accompanying drawings are incorporated into and form a part of this specification, showing embodiments consistent with this disclosure, and are used together with the specification to explain the principles of this disclosure. Obviously, the drawings described below are only some of the embodiments of this disclosure. Those of ordinary skill in the art can obtain other drawings without creative efforts.

FIG. 1 shows a flowchart of a method for network split tunneling according to one of exemplary embodiments of this disclosure.

FIG. 2 shows a flowchart of determining a target object for split tunneling that generates request traffic according to one of exemplary embodiments of this disclosure.

FIG. 3A shows a schematic diagram of an interface before tunnel node configuration according to one of exemplary embodiments of this disclosure.

FIG. 3B shows a schematic diagram of an interface after tunnel node configuration according to one of exemplary embodiments of this disclosure.

FIG. 3C shows a schematic diagram of an interface where no pre-configured object for split tunneling has been configured, according to one of exemplary embodiments of this disclosure.

FIG. 3D shows a schematic diagram of an interface where pre-configured objects for split tunneling have been configured, according to one of exemplary embodiments of this disclosure.

FIG. 3E shows a schematic diagram of a configuration information display interface, according to one of exemplary embodiments of this disclosure.

FIG. 3F shows a schematic diagram of an interface including a tunnel configuration sub-interface, according to one of exemplary embodiments of this disclosure.

FIG. 4 shows a flowchart of performing split tunneling in a VPN network with an application as an object for split tunneling, according to one of exemplary embodiments of this disclosure.

FIG. 5 shows a schematic diagram of a protocol stack according to one of exemplary embodiments of this disclosure.

FIG. 6 shows a structural block diagram of a device for network split tunneling according to one of exemplary embodiments of this disclosure.

FIG. 7 shows an electronic device for implementing the method for network split tunneling according to one of exemplary embodiments of this disclosure.

### DETAILED DESCRIPTION

Exemplary embodiments will now be described more comprehensively with reference to the accompanying drawings. However, the exemplary embodiments can be implemented in various forms and should not be construed as being limited to the examples set forth herein. On the contrary, these embodiments are provided so that this disclosure will be more comprehensive and complete, and the concept of the exemplary embodiments will be fully conveyed to those skilled in the art. The described features, structures, or characteristics can be combined in any suitable manner in one or more embodiments. In the following description, numerous specific details are provided to give a full understanding of the embodiments of this disclosure. However, those skilled in the art will understand that the technical solutions of this disclosure can be practiced without one or more of the specific details, or other methods, components, devices, steps, etc. can be used. In other cases, well-known technical solutions are not shown or described in detail to avoid attracting much attention and obscuring aspects of this disclosure.

In addition, the accompanying drawings are only schematic diagrams of this disclosure and are not necessarily drawn to scale. The same reference numerals in the drawings represent the same or similar elements, so their repeated description will be omitted. Some of block diagrams shown in the drawings are functional entities and do not necessarily have to correspond to physically or logically independent entities. These functional entities can be implemented in software form, or in one or more hardware modules or integrated circuits, or in different networks and/or processor devices and/or microcontroller devices.

In this disclosure, “first,” “second,” etc. are labels for specific objects and do not limit the number or order of the objects.

In related technologies, it is impossible to achieve split tunneling for different applications in the VPN network. It is difficult for VPN implementation methods to meet users'demands for simultaneous access to networks across different regions.

In view of one or more of the above-mentioned problems, a method for network split tunneling, a device for network split tunneling, a computer-readable storage medium, and an electronic device are provided according to exemplary embodiments of this disclosure. The applicable scenarios include but are not limited to cross-regional network access scenarios.

The method for network split tunneling, according to one of the embodiments of this disclosure, can run on a terminal device and be executed by a VPN client installed on the terminal device. For example, the terminal device can be a portable mobile terminal, such as a smart phone, a wearable device, a personal digital assistant (PDA), a vehicle-mounted computer, etc., or it can also be an electronic device such as a laptop computer or a tablet computer.

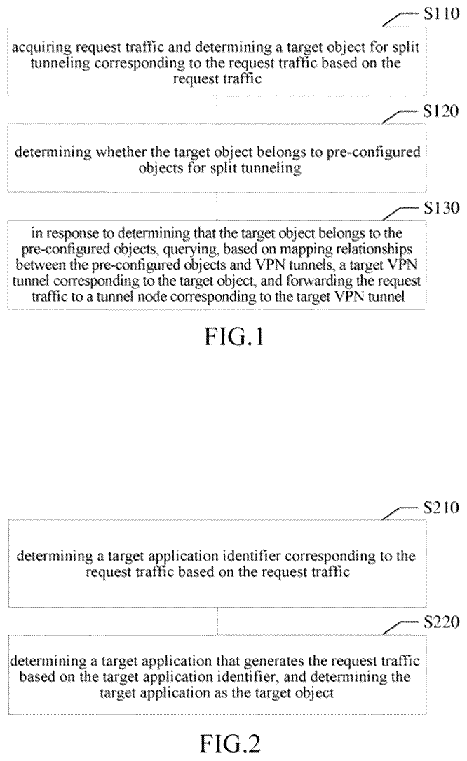

As shown in FIG. 1, it is a flowchart of the method for network split tunneling provided by an exemplary embodiment of this disclosure, which includes the following steps S110 to S140.

Step S110, acquiring request traffic and determining a target object for split tunneling corresponding to the request traffic based on the request traffic.

Step S120, determining whether the target object belongs to pre-configured objects for split tunneling.

Step S130, in response to determining that the target object belongs to the pre-configured objects, querying, based on mapping relationships between the pre-configured objects and VPN tunnels, a target VPN tunnel corresponding to the target object, and forwarding the request traffic to a tunnel node corresponding to the target VPN tunnel.

In some embodiments, in response to determining that the target object does not belong to the pre-configured objects, forwarding the request traffic to a tunnel node corresponding to a global VPN tunnel.

In the aforementioned network split tunneling processing, not only is split tunneling control implemented within the VPN network for request traffic, but it also satisfies users'demands to access networks across different regions simultaneously while ensuring secure data transmission.

The following is a specific description of each step in FIG. 1.

In step S110, request traffic is acquired, and a target object for split tunneling corresponding to the request traffic is determined based on the request traffic.

The request traffic refers to traffic data generated in the terminal device that needs to be forwarded to the network.

Optionally, an object for split tunneling can be an application or a domain name set. The application can be software of various types such as games, forums, and music. The domain name set can be a set of domain names composed of one or more domain names corresponding to service website(s). For example, taking Service Website A as an instance, the domain name set of Service Website A may include the domain name for accessing A's webpage, the domain name for accessing A's application, and may also include matching rules for matching the webpage access domain name or the application access domain name. This disclosure does not impose specific limitations on this aspect.

The pre-configured object for split tunneling (hereinafter referred to as “pre-configured object”) refers to an object that a user has configured for VPN network split tunneling. The pre-configured objects may include applications, domain name sets corresponding to service websites, etc.

The operating system of the terminal device where the VPN client is located includes but is not limited to the Android operating system and the iOS operating system.

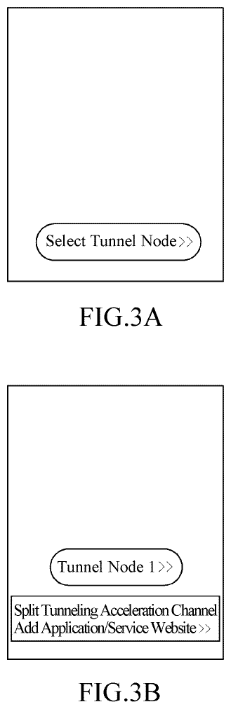

In an embodiment, when an application serves as the object for split tunneling, determining, based on the request traffic, a target object for split tunneling (hereinafter referred to as “target object”) that generates the request traffic, in step S110, can be implemented through the following steps as shown in FIG. 2.

Step S210, determining a target application identifier corresponding to the request traffic based on the request traffic.

Step S220, determining a target application that generates the request traffic based on the target application identifier, and determining the target application as the target object.

In the steps shown in FIG. 2, by determining the target application identifier, the target application is determined to distinguish the application to which the request traffic belongs, thereby realizing split tunneling for different applications in the VPN network and enabling users to access traffic from different regions simultaneously.

In step S210, a target application identifier corresponding to the request traffic is determined based on the request traffic.

An application identifier is an identity identifier set for an application, and different applications can be distinguished based on the application identifier.

In an embodiment, said determining the target application identifier corresponding to the request traffic based on the request traffic, in step S210, can be implemented through the following steps: determining five-tuple information corresponding to the request traffic, where the five-tuple information includes a transport protocol, a source address, a source port, a destination address, and a destination port; and determining the target application identifier corresponding to the request traffic based on the five-tuple information corresponding to the request traffic.

The transport protocol corresponding to the request traffic may be any one of the following transport protocols: Transmission Control Protocol (TCP), User Datagram Protocol (UDP), and Internet Control Message Protocol (ICMP), and this is not specifically limited here.

The five-tuple information corresponding to the request traffic can be obtained by reading the header information of the request traffic.

Taking the determination of the transport protocol in the five-tuple information as an example, the header information of the request traffic data can be read through a virtual network interface (such as Network TUNnel (TUN)), and the transport protocol corresponding to the request traffic can be obtained based on the header information of the request traffic. Here, TUN is a special type of network device that can be created by a user and allows direct reading and writing of network layer data in the form of file operations.

The target application identifier corresponding to the request traffic can be obtained through the five-tuple information corresponding to the request traffic at the application layer.

In an embodiment, said determining the target application identifier corresponding to the request traffic based on the five-tuple information corresponding to the request traffic can be implemented through the following steps: acquiring an Application Programming Interface (API) level corresponding to an operating system of a terminal, and determining whether the API level is greater than or equal to a level threshold; in response to determining that the API level is greater than or equal to the level threshold, determining the target application identifier corresponding to the request traffic by invoking a network connection management service interface based on the five-tuple information corresponding to the request traffic; in response to determining that the API level is less than the level threshold, determining the target application identifier corresponding to the request traffic by querying traffic statistics information in a /proc/net directory based on the five-tuple information corresponding to the request traffic.

For example, the threshold level is set to 29. If the API level corresponding to the terminal's operating system is greater than or equal to 29, the network connection management service interface can be invoked based on the five-tuple information corresponding to the request traffic, such as using the getConnectionOwnerUid method provided by the system service ConnectivityManager, to obtain the target application identifier. If the API level corresponding to the terminal's operating system is less than 29, the traffic statistics information can be queried in the /roc/net directory based on the five-tuple information corresponding to the request traffic, for example, by querying the information in files such as /proc/net/tcp, /proc/net/udp, and /proc/net/icmp, to obtain the target application identifier.

In step S220, based on the target application identifier, the target application that generates the request traffic is determined, and the target application is determined as the target object.

Based on a mapping relationship between an application identifier and an application, the application corresponding to the target application identifier is determined as the target application. There is a correspondence between the application identifier and the application. A mapping relationship table between application identifiers and applications can be created in advance to facilitate the query of the mapping relationship.

By determining the target application that generates the request traffic as the target object, it is convenient to further use the mapping relationship between the pre-configured object and the VPN tunnel to screen out the VPN tunnel for forwarding the request traffic.

In an embodiment, when a domain name set serves as an object for split tunneling, determining, based on the request traffic, a target object for split tunneling corresponding to the request traffic, in step S110, can be implemented through the following steps: determining domain name information corresponding to the request traffic; and determining a target domain name set to which the domain name information belongs based on the domain name information corresponding to the request traffic, and determining the target domain name set as the target object.

A domain name, also known as a web domain, is the name of a computer or a group of computers on the Internet, composed of a series of names separated by dots, and used to locate and identify the computer during data transmission. Each service website usually has one or more domain names. The VPN server can pre-collect common domain name sets on a per-service-website basis to obtain candidate domain name sets, in order to determine the target domain name set to which the domain name information corresponding to the request traffic belongs.

For example, the domain name information corresponding to the request traffic can be obtained by reading the header information of the request traffic.

If the domain name information corresponding to the request traffic cannot be obtained based on the header information, for example, the destination IP address of the request traffic can be obtained based on the header information and then the destination IP address can be queried in the DNS domain name cache to obtain the domain name information corresponding to the request traffic. The content cached in the DNS domain name cache includes the mapping relationships between domain names and IP addresses.

In an embodiment, said determining the target domain name set to which the domain name information belongs based on the domain name information corresponding to the request traffic can be implemented through the following steps: acquiring candidate domain name sets from a VPN server; and querying, based on the domain name information corresponding to the request traffic, the candidate domain name sets to determine the target domain name set to which the domain name information belongs.

The VPN client can obtain the candidate domain name sets from the VPN server, perform regular expression matching on the domain name information corresponding to the request traffic, determine the target domain name set to which the domain name information corresponding to the request traffic belongs from the candidate domain name sets, and use the determined target domain name set as the target object for split tunneling.

By determining the target domain name set to which the domain name information corresponding to the request traffic belongs as the target object, it is convenient to further use the mapping relationships between the pre-configured objects and the VPN tunnels to determine the target VPN tunnel for forwarding the request traffic.

It should be noted that, since the iOS operating system of the terminal device cannot directly read or access the applications installed on the terminal device when forwarding the request traffic, the common domain name sets collected by the VPN server can assist in determining the target domain name set. This helps to avoid the problem that the VPN client cannot read the installed applications when forwarding the request traffic on the iOS operating system, thus allowing the VPN client to perform selective split tunneling control on the iOS operating system.

In step S120, it is determined whether the target object belongs to the pre-configured objects for split tunneling.

The pre-configured object can be an application or a domain name set that a user has pre-configured through the VPN client for split tunneling control.

When determining whether the target object belongs to the pre-configured objects, there are two determination results. One is that the target object belongs to the pre-configured objects, and the other is that the target object does not belong to the pre-configured objects. Different processing steps can be executed according to the specific determination results, as described in steps S130 and S140.

In step S130, if the target object belongs to the pre-configured objects, a target VPN tunnel corresponding to the target object is queried based on mapping relationships between the pre-configured objects and VPN tunnels, to forward the request traffic to a tunnel node corresponding to the target VPN tunnel.

The mapping relationship between the pre-configured object and the VPN tunnel can be a mapping relationship, established by the user through the VPN client, between an application/domain name set for split tunneling and the VPN tunnel. The VPN tunnel in this disclosure can be a virtual private tunnel for achieving secure communication.

After determining the target VPN tunnel, the request traffic can be forwarded to the tunnel node corresponding to the target VPN tunnel to achieve split tunneling control in the VPN network.

In some embodiments, if the target object does not belong to the pre-configured objects, the request traffic is forwarded to a tunnel node corresponding to a global VPN tunnel.

The global VPN tunnel is a pre-designated VPN tunnel used to forward the request traffic corresponding to applications or domain name sets that have not been pre-configured for split tunneling. If the target object does not belong to the pre-configured objects, it means that the request traffic corresponding to the target object does not need to be subject to split tunneling control. In this case, the global VPN tunnel can be used for forwarding (or a local direct network can be used for network transmission). This is not only helpful for enhancing the security and privacy of traffic data transmission but also helpful for improving the efficiency and reliability of traffic data forwarding.

The pre-configured object and the mapping relationship between the pre-configured object and the VPN tunnel can be initially configured by the user when the VPN client is started for the first time. When the VPN client is started subsequently, the split tunneling control can be performed by directly reading the configuration information for split tunneling.

In an embodiment, before step S110, the following step can also be performed: determining, according to a configuration operation by a user for split tunneling, the pre-configured object and the mapping relationship between the pre-configured object and the VPN tunnel.

The configuration operation by the user for split tunneling (or called user's configuration operation for split tunneling) can include the configuration of pre-configured object(s), and the configuration of mapping relationship(s) between pre-configured object(s) and VPN tunnel(s). Through the user's configuration operation for split tunneling, the users can perform split tunneling configuration according to their own needs, thereby enhancing the controllability of the split tunneling process.

In an embodiment, said determining, according to a configuration operation by a user for split tunneling, the pre-configured object and the mapping relationship between the pre-configured object and the VPN tunnel can be implemented through the following steps:
in response to an operation for adding a tunnel node, determining a candidate tunnel node; in response to an operation for adding an object for split tunneling, determining the pre-configured object; in response to a tunnel node configuration operation for the pre-configured object, determining a tunnel node corresponding to the pre-configured object from the candidate tunnel nodes, and establishing the mapping relationship between the pre-configured object and the VPN tunnel where the tunnel node corresponding to the pre-configured object is located.

The candidate tunnel node can be a tunnel node added by the user in the configuration interface of the VPN client. The pre-configured object can be an object added by the user in the configuration interface of the VPN client for split tunneling.

Since the VPN tunnel contains corresponding tunnel nodes, candidate VPN tunnels can be provided to users through the configuration of these tunnel nodes. In practical application, to facilitate user operation, users can add tunnel nodes by specifying one or more access regions.

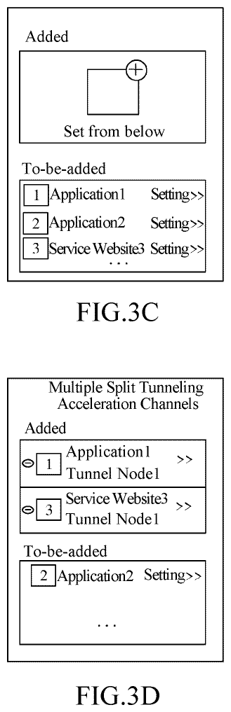

Taking split tunneling acceleration via VPN tunnels as an example, each VPN tunnel can be regarded as a channel for split tunneling acceleration. For example, as shown in FIGS. 3A and 3B, interface diagrams before and after tunnel node configuration are provided, respectively. Users can add tunnel nodes by clicking the “Select Tunnel Node” control in the configuration interface shown in FIG. 3A, thereby obtaining the configuration interface shown in FIG. 3B. Furthermore, users can navigate to the interface shown in FIG. 3C by clicking the “Split Tunneling Acceleration Channel” control in the configuration interface shown in FIG. 3B, to add objects for split tunneling.

FIG. 3C provides an interface diagram where no pre-configured object for split tunneling has been configured. Users can achieve the addition of pre-configured objects by moving applications/service websites from the “To-be-added” area to the “Added” area. As shown in FIG. 3D, an interface diagram where pre-configured objects for split tunneling have been configured is provided.

For example, the user can select any one of added applications/service websites in FIG. 3D for tunnel node configuration. It should be noted that in FIG. 3D, Application 1 and Service Website 3 configured for Tunnel Node 1 are only for exemplary illustration. In actual application, other tunnel nodes can be configured according to the user's needs, and this is not specifically limited here.

It should be noted that different service websites can correspond to different domain name sets. The VPN server can collect the domain name sets corresponding to different service websites and build mapping relationships between the service websites and the domain name sets, so that the VPN client can perform split tunneling with the domain name sets as the objects for split tunneling.

In an embodiment, the configuration of the pre-configured object and the mapping relationship between the pre-configured object and the VPN tunnel can also be updated according to a configuration update operation by a user for split tunneling (or called user's configuration update operation for split tunneling).

Users can adjust and modify the pre-configured object and/or the mapping relationship between the pre-configured object and the VPN tunnel in the VPN client at any time.

In response to the user's configuration update operation for split tunneling, the configuration of the pre-configured object and the mapping relationship between the pre-configured object and the VPN tunnel are updated according to the user's configuration update operation, to achieve real-time update of the split tunneling configuration.

Since the split tunneling configuration is updated in real-time according to the user's operation, it can take effect without restarting the VPN client, and at the same time, it can ensure that the network connection is not interrupted. This can not only meet the user's needs for network line changes but also will not add additional operational burdens to the user.

In an embodiment, said updating, according to the configuration update operation by the user for split tunneling, the configuration of the pre-configured object and the mapping relationship between the pre-configured object and the VPN tunnel can be implemented through the following steps: in response to the configuration update operation by the user in a configuration information display interface provided by a VPN client, displaying a configuration update interface to update the configuration of the pre-configured object and the mapping relationship between the pre-configured object and the VPN tunnel through the configuration update interface, where the configuration information display interface shows tunnel node configuration information corresponding to the pre-configured object.

For example, as shown in FIG. 3E, a schematic diagram of a configuration information display interface is provided. The user can click the “Edit” control to navigate to a configuration update interface shown in FIG. 3D for the user to update the configuration.

The configuration update operation for split tunneling can include the update of the configuration of the pre-configured object and the update of the configuration of the mapping relationship between the pre-configured object and the VPN tunnel. Through the user's configuration update operation for split tunneling, the users can update the split tunneling configuration at any time according to their own needs, thereby enhancing the controllability of the split tunneling process.

When updating the configuration of the mapping relationship between the pre-configured object and the VPN tunnel, in an embodiment, said updating the configuration of the pre-configured object and the mapping relationship between the pre-configured object and the VPN tunnel through the configuration update interface can be implemented through the following steps: in response to an operation by the user for selecting a pre-configured object in the configuration update interface, determining a pre-configured object to be updated, and displaying a tunnel configuration sub-interface corresponding to the pre-configured object to be updated; and in response to an operation by the user for updating a tunnel node in the tunnel configuration sub-interface, determining a new tunnel node for the pre-configured object to be updated, and updating a VPN tunnel corresponding to the pre-configured object to be updated based on the new tunnel node.

The operation for selecting a pre-configured object can be, for example, a click operation on any one of applications/service websites in the “Added” area in the interface of FIG. 3D.

The pre-configured object to be updated can be an object for split tunneling selected by the user from the pre-configured objects.

The tunnel configuration sub-interface refers to an interface for configuring the tunnel node for the pre-configured object. For example, as shown in FIG. 3F, an interface diagram including a tunnel configuration sub-interface is provided. Multiple candidate tunnel nodes can be displayed in the tunnel configuration sub-interface for the user to switch between tunnel nodes.

The operation for updating a tunnel node can be, for example, the user's operation for switching tunnel nodes in the tunnel configuration sub-interface. The new tunnel node refers to the latest tunnel node after the switch. After determining the new tunnel node corresponding to the pre-configured object to be updated, the VPN tunnel corresponding to the pre-configured object to be updated can be updated adaptively according to the new tunnel node, thereby realizing the update of the mapping relationship between the pre-configured object and the VPN tunnel.

Further, when updating the configuration of the pre-configured object, the update of the configuration of the pre-configured object can include the deletion of the pre-configured object and the addition of the pre-configured object.

In an embodiment, said updating the configuration of the pre-configured object and the mapping relationship between the pre-configured object and the VPN tunnel through the configuration update interface can be implemented through the following steps: in response to an operation by the user for deleting a pre-configured object in the configuration update interface, determining a pre-configured object to be deleted, and deleting the mapping relationship between the pre-configured object to be deleted and a VPN tunnel corresponding to the pre-configured object to be deleted.

The pre-configured object to be deleted refers to an object for split tunneling selected by the user from the pre-configured objects for deletion.

For example, as shown in FIG. 3D, the user can click the deletion control corresponding to any one of applications/service websites in the “Added” area to delete the pre-configured object. It should be noted that after deleting a pre-configured object, the mapping relationship of the VPN tunnel corresponding to the deleted pre-configured object can be synchronously deleted, thereby realizing the deletion of the pre-configured object.

In an embodiment, said updating the configuration of the pre-configured object and the mapping relationship between the pre-configured object and the VPN tunnel through the configuration update interface can also be implemented through the following steps: in response to an operation by the user for adding a pre-configured object in the configuration update interface, determining a pre-configured object to be added; and in response to an operation for configuring a tunnel node for the pre-configured object to be added, determining a tunnel node corresponding to the pre-configured object to be added, and establishing a mapping relationship between the pre-configured object to be added and a VPN line where the tunnel node corresponding to the pre-configured object to be added is located.

The pre-configured object to be added refers to an object selected by the user to serve as a pre-configured object for split tunneling.

For example, as shown in FIG. 3D, the user can achieve the addition of the pre-configured object by moving an application/service website from the “To-be-added” area to the “Added” area. It should be noted that after adding a pre-configured object, a tunnel node corresponding to the added pre-configured object can be further configured, and a mapping relationship can be created between the added pre-configured object and a VPN tunnel where the configured tunnel node is located, thereby realizing the addition of the pre-configured object.

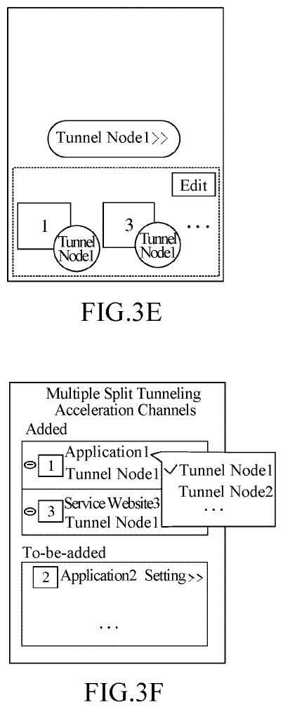

As shown in FIG. 4, a flowchart of performing split tunneling in a VPN network with an application as an object for split tunneling is provided, which can specifically include the following steps.

Step S401, acquiring request traffic, reading the request traffic through a virtual network interface, de-blocking the request traffic, and determining five-tuple information corresponding to the request traffic.

Step S402, acquiring an API level corresponding to an operating system of the terminal, determining whether the API level is greater than or equal to a threshold level, and if yes, proceeding to step S403; if no, proceeding to step S404.

Step S403, invoking a network connection management service interface based on the five-tuple information corresponding to the request traffic to determine a target application identifier corresponding to the request traffic.

Step S404, querying traffic statistics information in a /roc/net directory based on the five-tuple information corresponding to the request traffic to determine the target application identifier corresponding to the request traffic.

Step S405, determining a target application that generates the request traffic based on the target application identifier, and determining the target application as a target object for split tunneling.

Step S406, determining whether the target object belongs to pre-configured objects, and if yes, proceeding to step S407; if no, proceeding to step S408.

Step S407, querying a target VPN tunnel corresponding to the target object based on a mapping relationship between the pre-configured object and a VPN tunnel, to forward the request traffic to a tunnel node corresponding to the target VPN tunnel.

Step S408, forwarding the request traffic to a tunnel node corresponding to a global VPN tunnel.

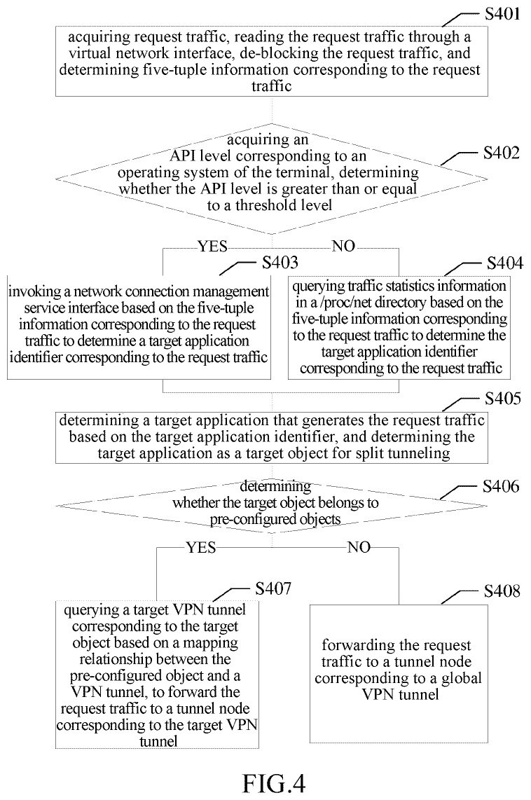

As shown in FIG. 5, a protocol stack diagram is provided. For example, the request traffic can be read through the virtual network interface TUN to obtain the five-tuple information corresponding to the request traffic. The five-tuple information includes the transport protocol, source address, source port, destination address, and destination port. The transport protocol corresponding to the request traffic can be any one of TCP, ICMP, and UDP. If the transport protocol corresponding to the request traffic is the TCP transport protocol, a hit determination can be performed, that is, determining whether the target object corresponding to the request traffic belongs to the pre-configured objects. After the hit determination, the request traffic can be forwarded through the transport channel established by TCP. If the transport protocol corresponding to the request traffic is the ICMP transport protocol, a hit determination can be performed, that is, determining whether the target object corresponding to the request traffic belongs to the pre-configured objects. After the determination, the request traffic can be forwarded through the transport channel established by ICMP. If the transport protocol corresponding to the request traffic is the UDP transport protocol, a hit determination can be performed, that is, determining whether the target object corresponding to the request traffic belongs to the pre-configured objects. After the determination, the request traffic can be forwarded through the transport channel established by UDP. It should be noted that when forwarding the request traffic, the request traffic can be forwarded according to the specific hit determination result. For example, if the target object corresponding to the request traffic belongs to the pre-configured objects, based on the mapping relationships between the pre-configured objects and the VPN tunnels, the target VPN tunnel corresponding to the target object can be queried to forward the request traffic to the tunnel node corresponding to the target VPN tunnel. If the target object corresponding to the request traffic does not belong to the pre-configured objects, the request traffic is forwarded to the tunnel node corresponding to the global VPN tunnel.

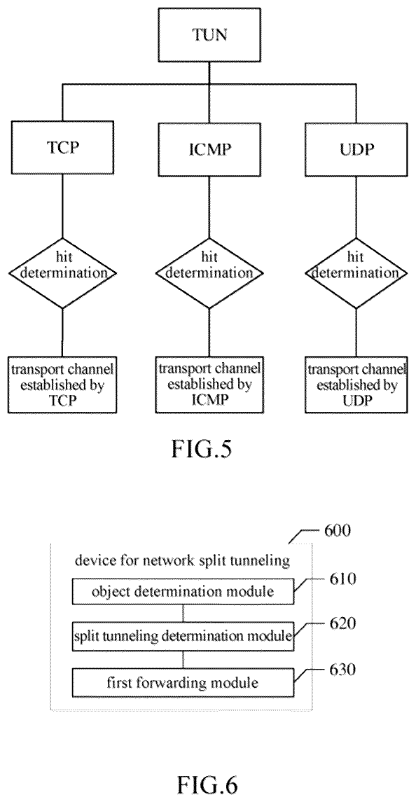

FIG. 6 shows a device 600 for network split tunneling according to an exemplary embodiment of the present disclosure. As shown in FIG. 6, the device 600 for network split tunneling may include:
an object determination module 610 configured to acquire request traffic and determine a target object for split tunneling corresponding to the request traffic based on the request traffic;
a split tunneling determination module 620 configured to determine whether the target object belongs to pre-configured objects for split tunneling; and
a first forwarding module 630 configured to, in response to determining that the target object belongs to the pre-configured objects, query, based on mapping relationships between the pre-configured objects and VPN tunnels, a target VPN tunnel corresponding to the target object, and forward the request traffic to a tunnel node corresponding to the target VPN tunnel.;

In some embodiments, the device 600 may further include a second forwarding module configured to, in response to determining that the target object does not belong to the pre-configured objects, forward the request traffic to a tunnel node corresponding to a global VPN tunnel.

In an embodiment, based on the foregoing solutions, when an application serves as an object for split tunneling, the object determination module 610 may include: an identifier determination module configured to determine a target application identifier corresponding to the request traffic based on the request traffic; and a first determination module configured to determine a target application that generates the request traffic based on the target application identifier, and determine the target application as the target object.

In an embodiment, based on the foregoing solutions, the identifier determination module may include: a tuple information determination module configured to determine five-tuple information corresponding to the request traffic, where the five-tuple information includes a transport protocol, a source address, a source port, a destination address, and a destination port; and an application identifier determination module configured to determine the target application identifier corresponding to the request traffic based on the five-tuple information corresponding to the request traffic.

In an embodiment, based on the foregoing solutions, the application identifier determination module may be configured to: acquire an API level corresponding to an operating system of a terminal, and determine whether the API level is greater than or equal to a level threshold; in response to determining that the API level is greater than or equal to the level threshold, determine the target application identifier corresponding to the request traffic by invoking a network connection management service interface based on the five-tuple information corresponding to the request traffic; in response to determining that the API level is less than the level threshold, determine the target application identifier corresponding to the request traffic by querying traffic statistics information in a /roc/net directory based on the five-tuple information corresponding to the request traffic.

In an embodiment, based on the foregoing solutions, when a domain name set serves as an object for split tunneling, the object determination module 610 further includes: a domain name information determination module configured to determine domain name information corresponding to the request traffic; and a second determination module configured to determine a target domain name set to which the domain name information belongs based on the domain name information corresponding to the request traffic, and determine the target domain name set as the target object.

In an embodiment, based on the foregoing solutions, the second determination module may be configured to: acquire candidate domain name sets from a VPN server; and determine the target domain name set to which the domain name information belongs by querying the candidate domain name sets based on the domain name information corresponding to the request traffic.

In an embodiment, based on the foregoing solutions, the device 600 for network split tunneling may further include: a split tunneling configuration module configured to determine, according to a configuration operation by a user for split tunneling, the pre-configured object and the mapping relationship between the pre-configured object and the VPN tunnel.

In an embodiment, based on the foregoing solutions, the mapping relationship configuration module may be configured to: in response to an operation for adding a tunnel node, determine a candidate tunnel node; in response to an operation for adding an object for split tunneling, determine the pre-configured object; in response to a tunnel node configuration operation for the pre-configured object, determine a tunnel node corresponding to the pre-configured object from candidate tunnel nodes, and establish the mapping relationship between the pre-configured object and the VPN tunnel where the tunnel node corresponding to the pre-configured object is located.

In an embodiment, based on the foregoing solutions, the device 600 for network split tunneling may further include: a split tunneling configuration update module configured to update, according to a configuration update operation by a user for split tunneling, a configuration of the pre-configured object and the mapping relationship between the pre-configured object and the VPN tunnel.

In an embodiment, based on the foregoing solutions, the split tunneling configuration update module further includes: a configuration update interface display module configured to, in response to the configuration update operation by the user in a configuration information display interface provided by a VPN client, display a configuration update interface to update the configuration of the pre-configured object and the mapping relationship between the pre-configured object and the VPN tunnel through the configuration update interface, where the configuration information display interface shows tunnel node configuration information corresponding to the pre-configured object.

In an embodiment, based on the foregoing solutions, the configuration update interface display module includes: an update object determination module configured to, in response to an operation by the user for selecting a pre-configured object in the configuration update interface, determine a pre-configured object to be updated, and display a tunnel configuration sub-interface corresponding to the pre-configured object to be updated; and a mapping relationship update module configured to, in response to an operation by the user for updating a tunnel node in the tunnel configuration sub-interface, determine a new tunnel node for the pre-configured object to be updated, and update a VPN tunnel corresponding to the pre-configured object to be updated based on the new tunnel node.

In an embodiment, based on the foregoing solutions, the configuration update interface display module further includes: a pre-configured object deletion module configured to, in response to an operation by the user for deleting a pre-configured object in the configuration update interface, determine a pre-configured object to be deleted, and delete the mapping relationship between the pre-configured object to be deleted and a VPN tunnel corresponding to the pre-configured object to be deleted.

In an embodiment, based on the foregoing solutions, the configuration update interface display module further includes: a pre-configured object addition module configured to, in response to an operation by the user for adding a pre-configured object in the configuration update interface, determine a pre-configured object to be added; and in response to an operation for configuring a tunnel node for the pre-configured object to be added, determine a tunnel node corresponding to the pre-configured object to be added, and establish a mapping relationship between the pre-configured object to be added and a VPN tunnel where the tunnel node corresponding to the pre-configured object to be added is located.

The specific details of each module in the above-mentioned device 600 for network split tunneling have been described in detail in the method embodiments. The undisclosed details can be referred to the method embodiments, so they will not be repeated here.

The exemplary embodiments of the present disclosure also provide a computer-readable storage medium, on which a program product capable of implementing the above-mentioned method for network split tunneling in this specification is stored. In some possible embodiments, various aspects of the present disclosure can also be implemented in the form of a program product. The program product includes program code. When the program product runs on an electronic device, the program code is used to make the electronic device execute the steps described in this specification according to various exemplary embodiments of the present disclosure.

Specifically, the program product can execute the following steps:
acquiring request traffic and determining a target object for split tunneling corresponding to the request traffic based on the request traffic;
determining whether the target object belongs to pre-configured objects for split tunneling; and
in response to determining that the target object belongs to the pre-configured objects, querying, based on mapping relationships between the pre-configured objects and VPN tunnels, a target VPN tunnel corresponding to the target object, and forwarding the request traffic to a tunnel node corresponding to the target VPN tunnel.

In some embodiments, the steps may further include: in response to determining that the target object does not belong to the pre-configured objects, forwarding the request traffic to a tunnel node corresponding to a global VPN tunnel.

In an embodiment, based on the foregoing solutions, when an application serves as an object for split tunneling, the above-mentioned determining the target object for split tunneling corresponding to the request traffic based on the request traffic can be implemented through the following steps: determining a target application identifier corresponding to the request traffic based on the request traffic; and determining a target application that generates the request traffic based on the target application identifier, and determining the target application as the target object.

In an embodiment, based on the foregoing solutions, the above-mentioned determining the target application identifier corresponding to the request traffic based on the request traffic can be implemented through the following steps: determining five-tuple information corresponding to the request traffic, where the five-tuple information includes a transport protocol, a source address, a source port, a destination address, and a destination port; and determining the target application identifier corresponding to the request traffic based on the five-tuple information corresponding to the request traffic.

In an embodiment, based on the foregoing solutions, the above-mentioned determining the target application identifier corresponding to the request traffic based on the five-tuple information corresponding to the request traffic can be implemented through the following steps: acquiring an API level corresponding to an operating system of a terminal, and determining whether the API level is greater than or equal to a level threshold; in response to determining that the API level is greater than or equal to the level threshold, determining the target application identifier corresponding to the request traffic by invoking a network connection management service interface based on the five-tuple information corresponding to the request traffic; in response to determining that the API level is less than the level threshold, determining the target application identifier corresponding to the request traffic by querying traffic statistics information in a /proc/net directory based on the five-tuple information corresponding to the request traffic.

In an embodiment, based on the foregoing solutions, when a domain name set serves as an object for split tunneling, the above-mentioned determining the target object for split tunneling corresponding to the request traffic based on the request traffic can be implemented through the following steps: determining domain name information corresponding to the request traffic; and determining a target domain name set to which the domain name information belongs based on the domain name information corresponding to the request traffic, and determining the target domain name set as the target object.

In an embodiment, based on the foregoing solutions, the above-mentioned determining the target domain name set to which the domain name information belongs based on the domain name information corresponding to the request traffic can be implemented through the following steps: acquiring candidate domain name sets from a VPN server; and determining the target domain name set to which the domain name information belongs by querying the candidate domain name sets based on the domain name information corresponding to the request traffic.

In an embodiment, based on the foregoing solutions, the following steps can also be executed: determining, according to a configuration operation by a user for split tunneling, the pre-configured object and the mapping relationship between the pre-configured object and the VPN tunnel.

In an embodiment, based on the foregoing solutions, the above-mentioned determining, according to the configuration operation by the user for split tunneling, the pre-configured object and the mapping relationship between the pre-configured object and the VPN tunnel can be implemented through the following steps: in response to an operation for adding a tunnel node, determining a candidate tunnel node; in response to an operation for adding an object for split tunneling, determining the pre-configured object; in response to a tunnel node configuration operation for the pre-configured object, determining a tunnel node corresponding to the pre-configured object from candidate tunnel nodes, and establishing the mapping relationship between the pre-configured object and the VPN tunnel where the tunnel node corresponding to the pre-configured object is located.

In an embodiment, based on the foregoing solutions, the following steps can also be executed: updating, according to a configuration update operation by a user for split tunneling, a configuration of the pre-configured object and the mapping relationship between the pre-configured object and the VPN tunnel.

In an embodiment, based on the foregoing solutions, the above-mentioned updating, according to the configuration update operation by the user for split tunneling, the configuration of the pre-configured object and the mapping relationship between the pre-configured object and the VPN tunnel can be implemented through the following steps: in response to the configuration update operation by the user in a configuration information display interface provided by a VPN client, displaying a configuration update interface to update the configuration of the pre-configured object and the mapping relationship between the pre-configured object and the VPN tunnel through the configuration update interface, where the configuration information display interface shows tunnel node configuration information corresponding to the pre-configured object.

In an embodiment, based on the foregoing solutions, the above-mentioned updating the configuration of the pre-configured object and the mapping relationship between the pre-configured object and the VPN tunnel through the configuration update interface can be implemented through the following steps: in response to an operation by the user for selecting a pre-configured object in the configuration update interface, determining a pre-configured object to be updated, and displaying a tunnel configuration sub-interface corresponding to the pre-configured object to be updated; and in response to an operation by the user for updating a tunnel node in the tunnel configuration sub-interface, determining a new tunnel node for the pre-configured object to be updated, and updating a VPN tunnel corresponding to the pre-configured object to be updated based on the new tunnel node.

In an embodiment, based on the foregoing solutions, the above-mentioned updating the configuration of the pre-configured object and the mapping relationship between the pre-configured object and the VPN tunnel through the configuration update interface can be implemented through the following steps: in response to an operation by the user for deleting a pre-configured object in the configuration update interface, determining a pre-configured object to be deleted, and deleting the mapping relationship between the pre-configured object to be deleted and a VPN tunnel corresponding to the pre-configured object to be deleted.

In an embodiment, based on the foregoing solutions, the above-mentioned updating the configuration of the pre-configured object and the mapping relationship between the pre-configured object and the VPN tunnel through the configuration update interface can be implemented through the following steps: in response to an operation by the user for adding a pre-configured object in the configuration update interface, determining a pre-configured object to be added; and in response to an operation for configuring a tunnel node for the pre-configured object to be added, determining a tunnel node corresponding to the pre-configured object to be added, and establishing a mapping relationship between the pre-configured object to be added and a VPN tunnel where the tunnel node corresponding to the pre-configured object to be added is located.

In the network split tunneling process as described above, not only is the split tunneling control of request traffic realized in the VPN network, but also it is ensured that the uses'demands for simultaneous access to networks across different regions can be met on the basis of ensuring the secure transmission of data.

The program product can be in the form of a portable compact disc read-only memory (CD-ROM) and include program code, and can run on an electronic device, such as a personal computer. However, the program product of the present disclosure is not limited thereto. In this disclosure, a readable storage medium can be any tangible medium that contains or stores a program, and the program can be used by or in combination with an instruction-execution system, apparatus, or device.

The program product can be a combination of one or more readable medium. The readable medium can be a readable signal medium or a readable storage medium. The readable storage medium can be, for example, but not limited to, a system, apparatus, or device of electricity, magnetism, light, electromagnetism, infrared, or semiconductor, or any combination thereof. More specific examples (a non-exhaustive list) of the readable storage medium include: an electrical connection with one or more wires, a portable disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

The readable signal medium can include a data signal propagated in a baseband or as a part of a carrier, in which readable program code is carried. Such a propagated data signal can take various forms, including but not limited to an electromagnetic signal, an optical signal, or any suitable combination thereof. The readable signal medium can also be any readable medium other than the readable storage medium, and this readable medium can transmit, propagate, or transfer a program for use by or in combination with an instruction-execution system, apparatus, or device.

The program code contained on the readable medium can be transmitted by any suitable medium, including but not limited to wireless, wire, optical cable, Radio Frequency (RF), etc., or any suitable combination thereof.

The program code for executing the operations of the present disclosure can be written in any combination of one or more programming languages. The programming languages include object-oriented programming languages such as Java and C++, and also include conventional procedural programming languages such as the “C” language or similar programming languages. The program code can be executed entirely on the user's computing device, partially on the user's device, as an independent software package, partially on the user's computing device and partially on a remote computing device, or entirely on a remote computing device or server. In the case of a remote computing device, the remote computing device can be connected to the user's computing device through any type of network, including a local area network (LAN) or a wide area network (WAN), or it can be connected to an external computing device (for example, through the Internet using an Internet service provider).

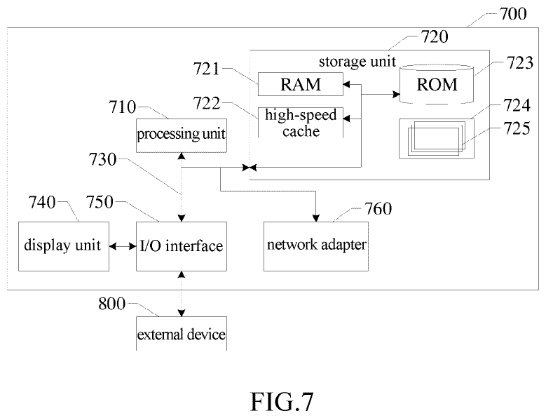

The exemplary embodiment of the present disclosure also provides an electronic device capable of implementing the above-mentioned method for network split tunneling. An electronic device 700 according to this exemplary embodiment of the present disclosure is described below with reference to FIG. 7. The electronic device 700 shown in FIG. 7 is merely an example and should not impose any limitations on the functionality and scope of use of the embodiments of the present disclosure.

As shown in FIG. 7, the electronic device 700 can be in the form of a general-purpose computing device. The components of the electronic device 700 can include, but are not limited to: at least one processing unit 710, at least one storage unit 720, a bus 730 connecting different system components (including the storage unit 720 and the processing unit 710), and a display unit 740.

The storage unit 720 stores program code, and the program code can be executed by the processing unit 710, enabling the processing unit 710 to execute the steps described in this specification according to various exemplary embodiments of the present disclosure.

Specifically, the processing unit 710 can execute the following steps: acquiring request traffic and determining a target object for split tunneling corresponding to the request traffic based on the request traffic;
determining whether the target object belongs to pre-configured objects for split tunneling; and
in response to determining that the target object belongs to the pre-configured objects, querying, based on mapping relationships between the pre-configured objects and VPN tunnels, a target VPN tunnel corresponding to the target object, and forwarding the request traffic to a tunnel node corresponding to the target VPN tunnel.

In some embodiments, the steps may include: in response to determining that the target object does not belong to the pre-configured objects, forwarding the request traffic to a tunnel node corresponding to a global VPN tunnel.

In an embodiment, based on the foregoing solutions, when an application serves as an object for split tunneling, the above-mentioned determining the target object for split tunneling corresponding to the request traffic based on the request traffic can be implemented through the following steps: determining a target application identifier corresponding to the request traffic based on the request traffic; and determining a target application that generates the request traffic based on the target application identifier, and determining the target application as the target object.

In an embodiment, based on the foregoing solutions, the above-mentioned determining the target application identifier corresponding to the request traffic based on the request traffic can be implemented through the following steps: determining five-tuple information corresponding to the request traffic, where the five-tuple information includes a transport protocol, a source address, a source port, a destination address, and a destination port; and determining the target application identifier corresponding to the request traffic based on the five-tuple information corresponding to the request traffic.

In an embodiment, based on the foregoing solutions, the above-mentioned determining the target application identifier corresponding to the request traffic based on the five-tuple information corresponding to the request traffic can be implemented through the following steps: acquiring an API level corresponding to an operating system of a terminal, and determining whether the API level is greater than or equal to a level threshold; in response to determining that the API level is greater than or equal to the level threshold, determining the target application identifier corresponding to the request traffic by invoking a network connection management service interface based on the five-tuple information corresponding to the request traffic; in response to determining that the API level is less than the level threshold, determining the target application identifier corresponding to the request traffic by querying traffic statistics information in a /proc/net directory based on the five-tuple information corresponding to the request traffic.

In an embodiment, based on the foregoing solutions, when a domain name set serves as an object for split tunneling, the above-mentioned determining the target object for split tunneling corresponding to the request traffic based on the request traffic can be implemented through the following steps: determining domain name information corresponding to the request traffic; and determining a target domain name set to which the domain name information belongs based on the domain name information corresponding to the request traffic, and determining the target domain name set as the target object.

In an embodiment, based on the foregoing solutions, the above-mentioned determining the target domain name set to which the domain name information belongs based on the domain name information corresponding to the request traffic can be implemented through the following steps: acquiring candidate domain name sets from a VPN server; and determining the target domain name set to which the domain name information belongs by querying the candidate domain name sets based on the domain name information corresponding to the request traffic.

In an embodiment, based on the foregoing solutions, the following steps can also be executed: determining, according to a configuration operation by a user for split tunneling, the pre-configured object and the mapping relationship between the pre-configured object and the VPN tunnel.

In an embodiment, based on the foregoing solutions, the above-mentioned determining, according to the configuration operation by the user for split tunneling, the pre-configured object and the mapping relationship between the pre-configured object and the VPN tunnel can be implemented through the following steps: in response to an operation for adding a tunnel node, determining a candidate tunnel node; in response to an operation for adding an object for split tunneling, determining the pre-configured object; in response to a tunnel node configuration operation for the pre-configured object, determining a tunnel node corresponding to the pre-configured object from candidate tunnel nodes, and establishing the mapping relationship between the pre-configured object and the VPN tunnel where the tunnel node corresponding to the pre-configured object is located.

In an embodiment, based on the foregoing solutions, the following steps can also be executed: updating, according to a configuration update operation by a user for split tunneling, a configuration of the pre-configured object and the mapping relationship between the pre-configured object and the VPN tunnel.

In an embodiment, based on the foregoing solutions, the above-mentioned updating, according to the configuration update operation by the user for split tunneling, the configuration of the pre-configured object and the mapping relationship between the pre-configured object and the VPN tunnel can be implemented through the following steps: in response to the configuration update operation by the user in a configuration information display interface provided by a VPN client, displaying a configuration update interface to update the configuration of the pre-configured object and the mapping relationship between the pre-configured object and the VPN tunnel through the configuration update interface, where the configuration information display interface shows tunnel node configuration information corresponding to the pre-configured object.

In an embodiment, based on the foregoing solutions, the above-mentioned updating the configuration of the pre-configured object and the mapping relationship between the pre-configured object and the VPN tunnel through the configuration update interface can be implemented through the following steps: in response to an operation by the user for selecting a pre-configured object in the configuration update interface, determining a pre-configured object to be updated, and displaying a tunnel configuration sub-interface corresponding to the pre-configured object to be updated; and in response to an operation by the user for updating a tunnel node in the tunnel configuration sub-interface, determining a new tunnel node for the pre-configured object to be updated, and updating a VPN tunnel corresponding to the pre-configured object to be updated based on the new tunnel node.

In an embodiment, based on the foregoing solutions, the above-mentioned updating the configuration of the pre-configured object and the mapping relationship between the pre-configured object and the VPN tunnel through the configuration update interface can be implemented through the following steps: in response to an operation by the user for deleting a pre-configured object in the configuration update interface, determining a pre-configured object to be deleted, and deleting the mapping relationship between the pre-configured object to be deleted and a VPN tunnel corresponding to the pre-configured object to be deleted.

In an embodiment, based on the foregoing solutions, the above-mentioned updating the configuration of the pre-configured object and the mapping relationship between the pre-configured object and the VPN tunnel through the configuration update interface can be implemented through the following steps: in response to an operation by the user for adding a pre-configured object in the configuration update interface, determining a pre-configured object to be added; and in response to an operation for configuring a tunnel node for the pre-configured object to be added, determining a tunnel node corresponding to the pre-configured object to be added, and establishing a mapping relationship between the pre-configured object to be added and a VPN tunnel where the tunnel node corresponding to the pre-configured object to be added is located.

In the network split tunneling process as described above, not only is the split tunneling control of request traffic realized in the VPN network, but also it is ensured that the uses'demands for simultaneous access to networks across different regions can be met on the basis of ensuring the secure transmission of data.

The storage unit 720 can include a readable medium in the form of a volatile storage unit, such as a random access storage unit (RAM) 721 and/or a high-speed cache storage unit 722, and can further include a read-only storage unit (ROM) 723.

The storage unit 720 can also include a program/utility 724 with a set of program modules 725 (at least one program module). Such program modules 725 include, but are not limited to, an operating system, one or more application programs, other program modules, and program data. Each or some combinations of these examples may include the implementation of a network environment.

The bus 730 can represent one or more of several types of bus structures, including a storage unit bus or a storage unit controller, a peripheral bus, a graphics acceleration port, a processing unit, or a local bus using any of the multiple bus structures.

The electronic device 700 can also communicate with one or more external devices 800 (such as a keyboard, a pointing device, a Bluetooth® device, etc.), communicate with one or more devices that enable the user to interact with the electronic device 700, and/or communicate with any device (such as a router, a modem, etc.) that enables the electronic device 700 to communicate with one or more other computing devices. This communication can be carried out through an input/output (I/O) interface 750. In addition, the electronic device 700 can also communicate with one or more networks (such as a local area network (LAN), a wide area network (WAN), and/or a public network, such as the Internet) through a network adapter 760. As shown in FIG. 7, the network adapter 760 communicates with other modules of the electronic device 700 through the bus 730. It should be understood that although not shown in FIG. 7, other hardware and/or software modules can be combined with the electronic device 700, including but not limited to microcode, device drivers, redundant processing units, external disk drive arrays, Redundant Arrays of Independent Disks (RAID) systems, tape drives, and data backup storage systems.

Through the description of the above-mentioned embodiments, those skilled in the art can easily understand that the exemplary embodiments described here can be implemented by software or by a combination of software and necessary hardware. Therefore, the technical solutions according to the embodiments of the present disclosure can be embodied in the form of a software product. The software product can be stored in a non-volatile storage medium (such as a CD-ROM, a USB flash drive, a mobile hard disk, etc.) or on a network, and includes several instructions to make a computing device (such as a personal computer, a server, a terminal device, or a network device) execute the method according to the exemplary embodiments of the present disclosure.

In addition, the above-mentioned accompanying drawings are only schematic illustrations of the processes included in the method according to the exemplary embodiments of the present disclosure, and are not for limiting purposes. It is easy to understand that the processes shown in the above-mentioned drawings do not indicate or limit the time sequence of these processes. In addition, it is also easy to understand that these processes can be executed synchronously or asynchronously in multiple modules.

It should be noted that although several modules or units of the device for action execution are mentioned in the above-mentioned detailed description, this division is not mandatory. In fact, according to the exemplary embodiments of the present disclosure, the features and functions of two or more modules or units described above can be embodied in one module or unit. Conversely, the features and functions of one module or unit described above can be further divided to be embodied by multiple modules or units.

After considering the specification and practicing the invention disclosed herein, those skilled in the art will readily conceive of other embodiments of the present disclosure. The present disclosure is intended to cover any variations, uses, or adaptations of the present disclosure. These variations, uses, or adaptations follow the general principles of the present disclosure and include common knowledge or conventional technical means in the technical field of the present disclosure that are not disclosed herein. The specification and embodiments are only considered exemplary, and the true scope and spirit of the present disclosure are indicated by the claims.

It should be understood that the present disclosure is not limited to the precise structure described above and shown in the drawings, and various modifications and changes can be made without departing from its scope. The scope of the present disclosure is only limited by the appended claims.

1. A method for network split tunneling, comprising:
acquiring, by a Virtual Private Network (VPN) client, request traffic;
determining, by the VPN client, a target object for split tunneling corresponding to the request traffic based on the request traffic;
determining, by the VPN client, whether the target object belongs to pre-configured objects for split tunneling;
in response to determining that the target object belongs to the pre-configured objects, querying, by the VPN client, based on mapping relationships between the pre-configured objects and tunnels, a target VPN tunnel corresponding to the target object; and
forwarding, by the VPN client, the request traffic to a tunnel node corresponding to the target VPN tunnel.

2. The method according to claim 1, wherein determining the target object for split tunneling corresponding to the request traffic based on the request traffic comprises:
determining, by the VPN client, a target application identifier corresponding to the request traffic based on the request traffic;
determining, by the VPN client, a target application that generates the request traffic based on the target application identifier; and
determining, by the VPN client, the target application as the target object.

3. The method according to claim 2, wherein determining the target application identifier corresponding to the request traffic based on the request traffic comprises:
determining, by the VPN client, five-tuple information corresponding to the request traffic, wherein the five-tuple information comprises a transport protocol, a source address, a source port, a destination address, and a destination port; and
determining, by the VPN client, the target application identifier corresponding to the request traffic based on the five-tuple information corresponding to the request traffic.

4. The method according to claim 3, wherein determining the target application identifier corresponding to the request traffic based on the five-tuple information corresponding to the request traffic comprises:
acquiring, by the VPN client, an Application Programming Interface (API) level corresponding to an operating system of a terminall
determining, by the VPN client, whether the API level is greater than or equal to a level threshold;
in response to determining that the API level is greater than or equal to the level threshold, determining, by the VPN client, the target application identifier corresponding to the request traffic by invoking a network connection management service interface based on the five-tuple information corresponding to the request traffic;
in response to determining that the API level is less than the level threshold, determining, by the VPN client, the target application identifier corresponding to the request traffic by querying traffic statistics information in a /proc/net directory based on the five-tuple information corresponding to the request traffic.

5. The method according to claim 1, wherein determining the target object for split tunneling corresponding to the request traffic based on the request traffic comprises:
determining, by the VPN client, domain name information corresponding to the request traffic;
determining, by the VPN client, a target domain name set based on the domain name information corresponding to the request traffic, wherein the target domain name set comprises the domain name information; and
determining, by the VPN client, the target domain name set as the target object.

6. The method according to claim 5, wherein determining the target domain name set based on the domain name information corresponding to the request traffic comprises:
acquiring, by the VPN client, candidate domain name sets from a VPN server; and
determining, by the VPN client, the target domain name set by querying the candidate domain name sets based on the domain name information corresponding to the request traffic.

7. The method according to claim 1, further comprising:
determining, by the VPN client, according to a configuration operation by a user for split tunneling, the pre-configured object and the mapping relationship between the pre-configured object and the VPN tunnel.

8. The method according to claim 7, wherein determining, according to the configuration operation by the user for split tunneling, the pre-configured object and the mapping relationship between the pre-configured object and the VPN tunnel comprises:
in response to an operation for adding a tunnel node, determining, by the VPN client, a candidate tunnel node;
in response to an operation for adding an object for split tunneling, determining, by the VPN client, the pre-configured object;
in response to a tunnel node configuration operation for the pre-configured object, determining, by the VPN client, a tunnel node corresponding to the pre-configured object from candidate tunnel nodes; and
establishing, by the VPN client, the mapping relationship between the pre-configured object and the VPN tunnel where the tunnel node corresponding to the pre-configured object is located.

9. The method according to claim 1, further comprising:
updating, by the VPN client, according to a configuration update operation by a user for split tunneling, a configuration of the pre-configured object and the mapping relationship between the pre-configured object and the VPN tunnel.

10. The method according to claim 9, wherein updating, according to the configuration update operation by the user for split tunneling, the configuration of the pre-configured object and the mapping relationship between the pre-configured object and the VPN tunnel comprises:
in response to the configuration update operation by the user in a configuration information display interface provided by a VPN client, displaying, by the VPN client, a configuration update interface to update the configuration of the pre-configured object and the mapping relationship between the pre-configured object and the VPN tunnel through the configuration update interface, wherein the configuration information display interface shows tunnel node configuration information corresponding to the pre-configured object.

11. The method according to claim 10, wherein updating the configuration of the pre-configured object and the mapping relationship between the pre-configured object and the VPN tunnel through the configuration update interface comprises:
in response to an operation by the user for selecting a pre-configured object in the configuration update interface, determining, by the VPN client, a pre-configured object to be updated, and displaying, by the VPN client, a tunnel configuration sub-interface corresponding to the pre-configured object to be updated; and
in response to an operation by the user for updating a tunnel node in the tunnel configuration sub-interface, determining, by the VPN client, a new tunnel node for the pre-configured object to be updated, and updating, by the VPN client. a VPN tunnel corresponding to the pre-configured object to be updated based on the new tunnel node.

12. The method according to claim 10, wherein updating the configuration of the pre-configured object and the mapping relationship between the pre-Amdt. configured object and the VPN tunnel through the configuration update interface comprises:
in response to an operation by the user for deleting a pre-configured object in the configuration update interface, determining, by the VPN client, a pre-configured object to be deleted, and deleting, by the VPN client, the mapping relationship between the pre-configured object to be deleted and a VPN tunnel corresponding to the pre-configured object to be deleted.

13. The method according to claim 10, wherein updating the configuration of the pre-configured object and the mapping relationship between the pre-configured object and the VPN tunnel through the configuration update interface comprises:
in response to an operation by the user for adding a pre-configured object in the configuration update interface, determining, by the VPN client, a pre-configured object to be added; and
in response to an operation for configuring a tunnel node for the pre-configured object to be added, determining, by the VPN client, a tunnel node corresponding to the pre-configured object to be added, and establishing, by the VPN client, a mapping relationship between the pre-configured object to be added and a VPN tunnel where the tunnel node corresponding to the pre-configured object to be added is located.

14. (canceled)

15. A non-transitory_computer-readable storage medium, storing a computer program that, when executed by a processor, causes the processor to perform following acts:
acquiring request traffic and determining a target object for split tunneling corresponding to the request traffic based on the request traffic;
determining whether the target object belongs to pre-configured objects for split tunneling: and
in response to determining that the target object belongs to the pre-configured objects. querying, based on mapping relationships between the pre-configured objects and VPN tunnels, a target VPN tunnel corresponding to the target object, and forwarding the request traffic to a tunnel node corresponding to the target VPN tunnel.

16. An electronic device, comprising:
a processor; and
a memory configured to store instructions executable by the processor;
wherein the processor is configured to:
acquire request traffic and determining a target object for split tunneling corresponding to the request traffic based on the request traffic;
determine whether the target object belongs to pre-configured objects for split tunneling; and
in response to determining that the target object belongs to the pre-configured objects, query. based on mapping relationships between the pre-configured objects and VPN tunnels, a target VPN tunnel corresponding to the target object, and forward the request traffic to a tunnel node corresponding to the target VPN tunnel.

17. The method according to claim 5, wherein determining the target domain name set to which the domain name information belongs based on the domain name information corresponding to the request traffic comprises:
in response to determining that an operating system of a terminal is a iOS operating system, acquiring, by the VPN client, common domain name sets from a VPN server; and
determining, by the VPN client, the target domain name set by querying the common domain name sets based on the domain name information corresponding to the request traffic.

18. The electronic device according to claim 16, wherein the processor is configured to:
determine a target application identifier corresponding to the request traffic based on the request traffic;
determine a target application that generates the request traffic based on the target application identifier; and
determine the target application as the target object.

19. The electronic device according to claim 18, wherein the processor is configured to:
determine five-tuple information corresponding to the request traffic, wherein the five-tuple information comprises a transport protocol, a source address, a source port, a destination address, and a destination port; and
determine the target application identifier corresponding to the request traffic based on the five-tuple information corresponding to the request traffic.

20. The electronic device according to claim 19, wherein the processor is configured to:
acquire an Application Programming Interface (API) level corresponding to an operating system of a terminal;
determine whether the API level is greater than or equal to a level threshold;
in response to determining that the API level is greater than or equal to the level threshold, determine the target application identifier corresponding to the request traffic by invoking a network connection management service interface based on the five-tuple information corresponding to the request traffic;
in response to determining that the API level is less than the level threshold, determine the target application identifier corresponding to the request traffic by querying traffic statistics information in a /proc/net directory based on the five-tuple information corresponding to the request traffic.

21. The electronic device according to claim 16, wherein the processor is configured to:
determine domain name information corresponding to the request traffic;
determine a target domain name set based on the domain name information corresponding to the request traffic, wherein the target domain name set comprises the domain name information; and
determine the target domain name set as the target object.
